(19) United States
(12) Patent Application Publication
(10) Pub. No.: US 2024/0142704 A1
(43) Pub. Date: May 2, 2024

(54) SINGLE SUBSTRATE LIGHTGUIDE WITH FACETS

(71) Applicant: GOOGLE LLC, Mountain View, CA (US)

(72) Inventors: Daniel Adema, Kitchener (CA); Timothy Paul Bodiya, Toronto (CA); Rhys Anderson, Kitchener (CA)

(21) Appl. No.: 18/496,257

(22) Filed: Oct. 27, 2023

Related U.S. Application Data
(60) Provisional application No. 63/420,240, filed on Oct. 28, 2022.

(51) Int. Cl. G02B 6/26; G02B 27/01

(52) U.S. Cl. CPC G02B 6/262; G02B 27/0172; G02B 1/18

(57) ABSTRACT

A lightguide formed from a single substrate includes a substrate and a plurality of reflective structures disposed on the substrate. These reflective structures form one or more incouplers, exit pupil expanders, and outcouplers of the lightguide and are each configured to reflect light representative of an image. The lightguide also includes an effectively transparent overmold material disposed over the reflective structures that, together with at least a portion of the substrate, forms a first surface of the substrate. Further, the lightguide includes a second surface formed by removing at least a portion of the substrate via a material removal operation.

### CROSS-REFERENCE TO RELATED APPLICATIONS

The present application claims priority to U.S. Provisional Application No. 63/420,240, entitled “SINGLE SUBSTRATE REFLECTIVE FACET LIGHTGUIDE,” and filed on Oct. 28, 2022, the entirety of which is incorporated by reference herein.

### BACKGROUND

Some head-worn displays (HWDs) are configured to provide beams of light representative of an image to the eye of a user. To this end, some HWDs include a projector that emits beams of light representative of an image to a lightguide formed from one or more substrates. Such a lightguide includes an incoupler that directs the beams of light from the projector into the lightguide such that the beams of light propagate through the lightguide. To direct the beams of light into the lightguide, the incoupler includes a set of structures disposed on or within the lightguide that is configured to direct the beams of light into the lightguide such that the beams of light propagate through the lightguide by multiple instances of total internal reflection (TIR). Further, the lightguide includes an outcoupler configured to direct the beams of light propagating in the lightguide out of the lightguide and toward the eye of a user. To this end, the outcoupler also includes a set of structures disposed on or within the lightguide configured to receive the beams of light propagating through the lightguide. In response to receiving the beams of light, the structures of the outcoupler are configured to direct the beams of light out of the lightguide such that the beams of light overlap at an eye-relief distance from the lightguide and form an exit pupil within which a virtual image can be viewed by the eye of the user.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of an example display system housing a laser projector system configured to project images toward the eye of a user using a single substrate lightguide, in accordance with some embodiments.

FIG. 2 is a diagram illustrating a laser projection system that projects images directly onto the eye of a user via laser light, in accordance with some embodiments.

FIG. 3 is a diagram illustrating an example lightguide including an incoupler, outcoupler, and exit pupil expansion system, in accordance with embodiments.

FIGS. 4 and 5 are diagrams together illustrating a lightguide formed from two substrates, in accordance with some embodiments.

FIG. 6 is a diagram illustrating a single substrate lightguide, in accordance with some embodiments.

FIG. 7 is a diagram illustrating a material removal process for a single substrate lightguide, in accordance with some embodiments.

FIG. 8 is a diagram illustrating a single substrate lightguide after a material removal process, in accordance with some embodiments.

FIG. 9 is a diagram illustrating a material removal process for a lightguide formed from two substrates, in accordance with some embodiments.

FIG. 10 is a diagram illustrating a lightguide formed from two substrates after a material removal process, in accordance with some embodiments.

FIG. 11 is a diagram illustrating a partially transparent view of a head-worn display (HWD) that includes a laser projection system, in accordance with some embodiments

### DETAILED DESCRIPTION

Transmitting light from a projector to a user's eye in a head-worn display (HWD) generally includes light being received at an incoupler of a lightguide. This incoupler includes, for example, one or more reflective structures configured to reflect the received light into the main body of the lightguide. The light then propagates along the lightguide using total internal reflection (TIR), partial internal reflection (PIR), or both. That is to say, the lightguide includes one or more reflective structures configured to reflect received light such that the light bounces off the surfaces of the lightguide so as to propagate through the lightguide. Further, to help transmit the light to a user's eye, the main body of the lightguide includes an exit pupil expander (EPE) configured to expand the propagating light in one or more directions before the light is provided to the user's eye. For example, an EPE includes a set of reflective structures configured to reflect the propagating light so as to expand the light in one or more directions. Further, the main body of the light guide includes an outcoupler configured to direct the propagating light out of the lightguide. For example, the outcoupler includes a set of reflective structures configured to reflect light such that the light is directed out of the light guide and toward the eye of a user.

These lightguides, for example, often include plastic-formed parts or plastic-embossed parts to form the reflective structures of the lightguide. However, these plastic-formed parts or plastic-embossed parts often introduce a thickness of material (e.g., substrate) between the reflective structures and the surfaces of the lightguide. For example, these plastic-formed parts or plastic-embossed parts often introduce a thickness of material (e.g., substrate) between a first end (e.g., root) of a reflection structure and a first surface (e.g., bottom surface) of the lightguide, a second end (e.g., tip) of the reflection structure and a second surface (e.g., top surface) of the lightguide, or both. These thicknesses of material between the reflection structures and the surfaces of the lightguide negatively affect the propagation of light within the lightguide, increasing the likelihood that the quality of the image provided to a user deteriorates and negatively impacting user experience.

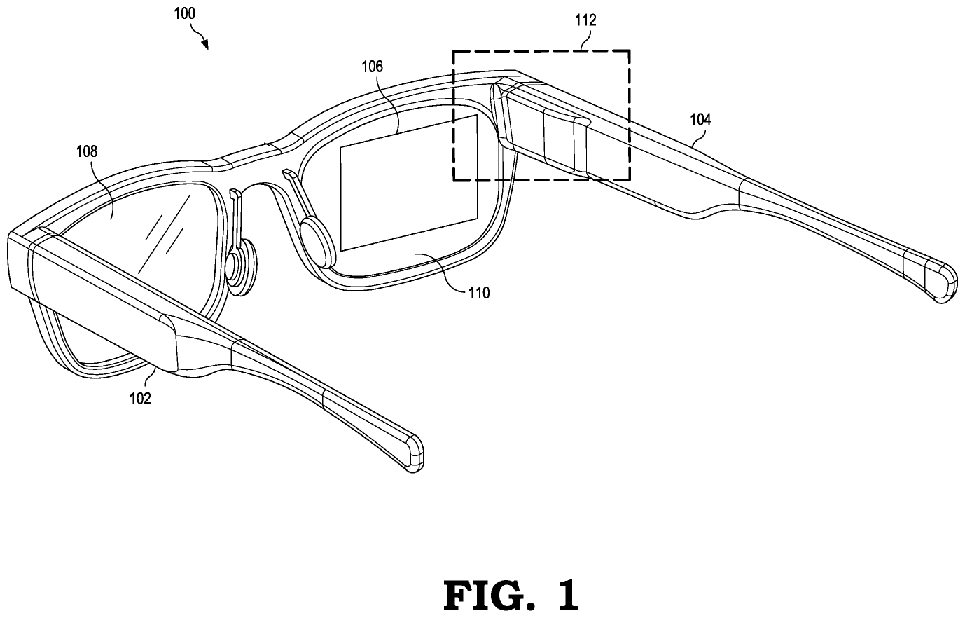

To this end, FIGS. 1-11 present systems and techniques directed to reducing the thickness of material between the reflection structures and the surfaces of a lightguide. For example, a lightguide formed from a single substrate (e.g., a single substrate lightguide) is disclosed herein. A single substrate lightguide, for example, includes a substrate (e.g., glass substrate, plastic substrate) having opposing surfaces. Further, the substrate includes one or more reflective structures disposed thereon. These reflective structures, for example, form one or more incouplers, EPEs, outcouplers, or any combination thereof and are configured to reflect received light so as to provide light from a projector to the eye of a user. For example, these reflective structures include reflective facets, electrochromic facets, beam splitters (e.g., polarized beam splitters), mirrors (e.g., dielectric mirrors, dichromic mirrors), reflective coatings, or any combination thereof, to name a few. As an example, one or more reflective structures include a reflective coating (e.g., dielectric mirror coating, metallic coating, holographic coating, dichroic mirror coating, polarization-selective mirror coating) configured to reflect received light. Additionally, the single substrate lightguide includes an overcoat material that is disposed on each reflective structure so as to form the first surface (e.g., top surface) of the single substrate lightguide. This overcoat material includes, for example, an effectively transparent material (e.g., a material that allows a user to see through the material), such as plastic, that is injection molded, spin coated, blade coated, slot coated, laminated, or any combination thereof on each reflective structure of the substrate. Further, the overcoat material is disposed on the reflective structures such that there is effectively no thickness of material (e.g., overcoat material) between the top ends of the reflective structures and the first surface of the lightguide. That is to say, the overcoat material is disposed on the reflective structures such that the lightguide functions as if there is no thickness of material between the top ends of the reflective structures and the first surface of the lightguide.

Further, the single substrate lightguide includes a second surface (e.g., bottom surface) formed from at least a portion of the substrate after a material removal process. Such a material removal process, for example, removes at least a portion of the substrate via cutting, polishing, or both so as to reduce the thickness of the substrate between the ends (e.g., bottom ends) of the reflective facets and the second surface of the lightguide. The surfaces of the single substrate lightguide also each include a surface coating disposed thereon that protects the lightguide, gives one or more properties to the surfaces of the lightguide, or both. Such surface coatings include, for example, a hard coating, an oleophobic coating, a hydrophobic coating, or the like. In this way, the thicknesses of material between the ends of reflection structures and the surfaces of the lightguide are reduced, helping to ensure that light propagates through the lightguide as intended. Additionally, reducing such thicknesses of material helps decrease the size of the lightguide and, in turn, an HWD incorporating the lightguide, which improves user experience.

Referring now to FIG. 1, FIG. 1 illustrates an example display system 100 having a support structure 102 that includes an arm 104, which houses a projection system configured to project display light representative of images toward the eye of a user, such that the user perceives the projected images as being displayed in a field of view (FOV) area 106 of a display at one or both of lens elements 108, 110. In the depicted embodiment, the display system 100 is an HWD that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a projector, an optical scanner, and a lightguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in some embodiments, the support structure 102 further includes one or more batteries or other portable power sources for supplying power to the electrical components of the display system 100. In some embodiments, some, or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an extended reality (XR) display in which rendered graphical content can be superimposed over or otherwise provided in conjunction with a real-world view as perceived by the user through the lens elements 108, 110. For example, display light used to form a perceptible image or series of images may be projected by a projector of the display system 100 onto the eye of the user via a series of optical elements, such as a lightguide formed at least partially in the corresponding lens element, one or more scan mirrors, and one or more optical relays. One or both of the lens elements 108, 110 thus include at least a portion of a lightguide that routes display light received by an incoupler of the lightguide to an outcoupler of the lightguide, which outputs the display light toward the eye of a user of the display system 100. The display light is modulated and scanned onto the eye of the user such that the user perceives the display light as an image. In addition, each of the lens elements 108, 110 is sufficiently transparent to allow a user to see through the lens elements to provide an FOV of the user's real-world environment such that the image appears superimposed over at least a portion of the real-world environment. According to embodiments, the incoupler of the lightguide includes a respective set of reflective structures configured to direct light into the lightguide such that the light propagates through the lightguide using TIR, PIR, or both. Such reflective structures include, for example, reflective facets, electrochromic facets, beam splitters (e.g., polarized beam splitters), mirrors (e.g., dielectric mirrors, dichromic mirrors), reflective coatings (e.g., metallic coatings, holograms), or any combination thereof. Further, the outcoupler of the lightguide also includes a respective set of reflective structures (e.g., reflective facets, electrochromic facets, beam splitters, mirrors, reflective coatings) configured to receive the light from the incoupler and direct the light out of the lightguide and toward the eye of a user so to present an image to the user. In embodiments, the lightguide included in lens elements 108, 110 is formed from a single substrate lightguide that is cut, polished, or both so as to reduce the distance from the ends (e.g., bottom ends) of the reflective structures of the incoupler and a surface of the lightguide, the ends of reflective facets of the outcoupler and a surface of the lightguide, or both.

In some embodiments, the projector is a digital light processing-based projector, a microdisplay, scanning laser projector, or any combination of a modulative light source. For example, according to some embodiments, the projector includes a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be MEMS-based or piezo-based). The projector is communicatively coupled to the controller and a non-transitory processor-readable storage medium or a memory that stores processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106 and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

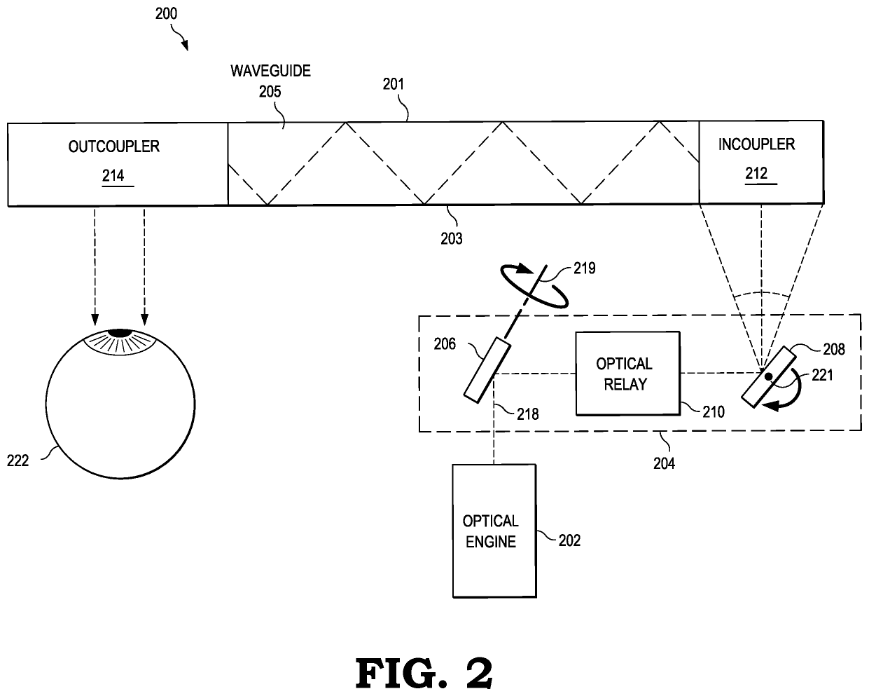

FIG. 2 illustrates a simplified block diagram of a projection system 200 that projects images directly onto the eye of a user via display light. The projection system 200 includes an optical engine 202, an optical scanner 204, and a lightguide 205. The optical scanner 204 includes a first scan mirror 206, a second scan mirror 208, and an optical relay 210. The lightguide 205 has a first surface 201 and a second, opposing surface 203. Further, the lightguide 205 includes an incoupler 212 and an outcoupler 216, with the outcoupler 216 being optically aligned with an eye 222 of a user in the present example. In some embodiments, the projection system 200 is implemented in an HMD or other display system, such as the display system 100 of FIG. 1.

The optical engine 202 includes one or more light sources configured to generate and output display light 218 (e.g., visible light such as red, blue, and green light and/or non-visible light such as infrared light). These light sources, for example, include one or more lasers, light-emitting diodes (LEDs), organic LEDs (OLEDs), or any combination thereof. In some embodiments, the optical engine 202 is coupled to a driver or other controller (not shown), which controls the timing of emission of light from the light sources of the optical engine 202 in accordance with instructions received by the controller or driver from a computer processor coupled thereto to modulate the display light 218 to be perceived as images when output to the retina of an eye 222 of a user.

For example, during the operation of the projection system 200, multiple display light beams having respectively different wavelengths are output by the light sources of the optical engine 202, then combined via a beam combiner (not shown), before being directed to the eye 222 of the user. As an example, the projection system 200 emits a first display light beam having a first wavelength associated with green light, a second display light beam having a second wavelength associated with red light, and a third display light beam having a third wavelength associated with blue light. The optical engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time.

One or both of the scan mirrors 206 and 208 of the optical scanner 204 are MEMS mirrors in some embodiments. For example, in some embodiments, the scan mirror 206 and the scan mirror 208 are MEMS mirrors that are driven by respective actuation voltages to oscillate during active operation of the projection system 200, causing the scan mirrors 206 and 208 to scan the display light 218. Oscillation of the scan mirror 206 causes display light 218 output by the optical engine 202 to be scanned through the optical relay 210 and across a surface of the second scan mirror 208. The second scan mirror 208 scans the display light 218 received from the scan mirror 206 toward an incoupler 212 of the lightguide 205. In some embodiments, the scan mirror 206 oscillates along a first scanning axis 219, such that the display light 218 is scanned in only one dimension (e.g., in a line) across the surface of the second scan mirror 208. In some embodiments, the scan mirror 208 oscillates or otherwise rotates along a second scanning axis 221. In some embodiments, the first scanning axis 219 is perpendicular to the second scanning axis 221.

In some embodiments, the incoupler 212 has a substantially rectangular, circular, or elliptical profile and is configured to receive the display light 218 and direct the display light 218 into the lightguide 205. The incoupler 212 is defined by a smaller dimension (i.e., width) and a larger orthogonal dimension (i.e., length). In an embodiment, the optical relay 210 is a line-scan optical relay that receives the display light 218 scanned in a first dimension by the first scan mirror 206 (e.g., the first dimension corresponding to the small dimension of the incoupler 212), routes the display light 218 to the second scan mirror 208, and introduces a convergence to the display light 218 in the first dimension to an exit pupil beyond the second scan mirror 208. Herein, an “exit pupil” in an optical system refers to the location along the optical path where beams of light intersect. For example, the possible optical paths of the display light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the display light 218 corresponding to that exit pupil. Accordingly, the exit pupil can be considered a “virtual aperture”. According to various embodiments, the optical relay 210 includes one or more collimation lenses that shape and focus the display light 218 on the second scan mirror 208 or includes a molded reflective relay that includes two or more spherical, aspheric, parabolic, and/or freeform lenses that shape and direct the display light 218 onto the second scan mirror 208. The second scan mirror 208 receives the display light 218 and scans the display light 218 in a second dimension, the second dimension corresponding to the long dimension of the incoupler 212 of the lightguide 205. In some embodiments, the second scan mirror 208 causes the exit pupil of the display light 218 to be swept along a line along the second dimension. In some embodiments, the incoupler 212 is positioned at or near the swept line downstream from the second scan mirror 208 such that the second scan mirror 208 scans the display light 218 as a line or row over the incoupler 212.

In some embodiments, the optical engine 202 includes an edge-emitting laser (EEL) that emits a display light 218 having a substantially elliptical, non-circular cross-section, and the optical relay 210 magnifies or minimizes the display light 218 along its semi-major or semi-minor axis to circularize the display light 218 prior to the convergence of the display light 218 on the second scan mirror 208. In some such embodiments, a surface of a mirror plate of the scan mirror 206 is elliptical and non-circular (e.g., similar in shape and size to the cross-sectional area of the display light 218). In other such embodiments, the surface of the mirror plate of the scan mirror 206 is circular.

The lightguide 205 of the projection system 200 includes the incoupler 212 and the outcoupler 216. The term “lightguide,” as used herein, will be understood to mean a combiner using one or more of TIR, PIR, specialized filters, and/or reflective surfaces, to transfer light from an incoupler (such as the incoupler 212) to an outcoupler (such as the outcoupler 216). In some display applications, the light is a collimated image, and the lightguide transfers and replicates the collimated image to the eye. In general, the terms “incoupler” and “outcoupler” will be understood to refer to a set of any type of reflective structures, including, but not limited to, reflective facets, electrochromic facets, beam splitters (e.g., polarized beam splitters), mirrors (e.g., dielectric mirrors, dichromic mirrors), reflective coatings (e.g., metallic coatings, holograms), or any combination thereof. According to some embodiments, the lightguide 205 is formed from a single substrate. For example, the lightguide 205 includes a single glass substrate or plastic substrate having one or more structures representative of one or more reflective structures for an incoupler (e.g., incoupler 212), an exit pupil expander (EPE), outcoupler (e.g., outcoupler 216), or any combination thereof. As an example, in some embodiments, the lightguide 205 includes a pattern of structures formed from at least a portion of a single substrate that represents one or more reflective structures for an incoupler (e.g., incoupler 212), an exit pupil expander (EPE), outcoupler (e.g., outcoupler 216), or any combination thereof. Additionally, according to some embodiments, the single substrate of the lightguide 205 includes one or more coatings (e.g., mirror coatings, reflective coatings) deposited on the structures of the lightguide 205 to form one or more reflective structures. In embodiments, the lightguide 205 includes an effectively transparent overcoat material (e.g., a material allowing a user to see through the material), such as plastic, deposited over the reflective structures so as to protect the reflective structures from external forces (e.g., users, dirt, dust, water) and to allow for propagation of light via TIR, PIR, or both. The lightguide 205, in some embodiments, also includes a surface coating (e.g., hard coating, oleophobic coating, hydrophobic coating) deposited over the overcoat material so as to protect the lightguide 205, provide one or more properties to the surface of the lightguide 205 (e.g., oleophobic properties, hydrophobic properties) or both.

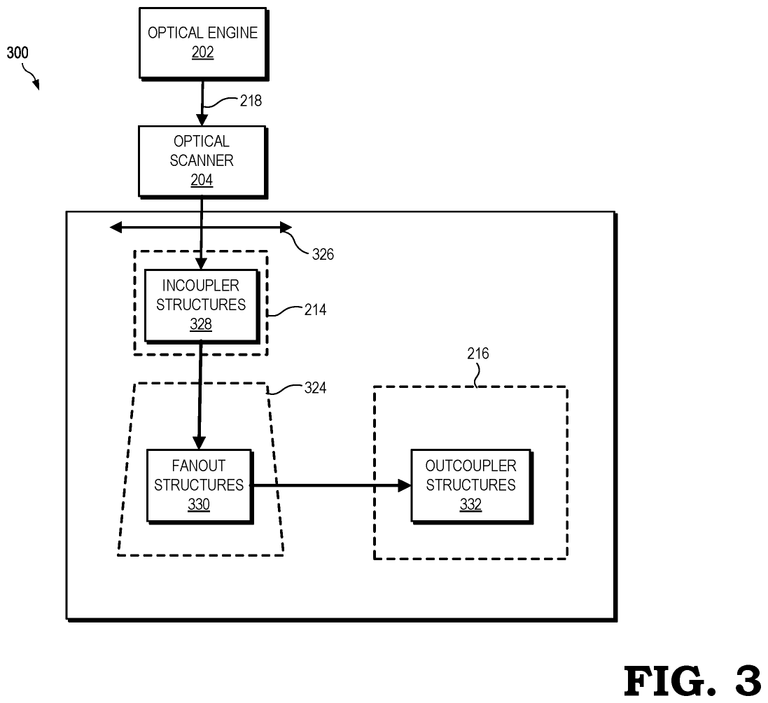

In the present example, the display light 218 received at the incoupler 212 is relayed to the outcoupler 216 via the lightguide 205 using TIR, PIR, or both. The display light 218 is then output to the eye 222 of a user via the outcoupler 216. As described above, in some embodiments the lightguide 205 is implemented as part of an eyeglass lens, such as the lens element 108 or lens element 110 (e.g., FIG. 1) of the display system having an eyeglass form factor and employing the projection system 200. Although not shown in the example of FIG. 2, in some embodiments additional optical components are included in any of the optical paths between the optical engine 202 and the scan mirror 206, between the scan mirror 206 and the optical relay 210, between the optical relay 210 and the scan mirror 208, between the scan mirror 208 and the incoupler 212, between the incoupler 212 and the outcoupler 216, and/or between the outcoupler 216 and the eye 222 (e.g., in order to shape the display light for viewing by the eye 222 of the user). In some embodiments, a prism is used to steer display light from the scan mirror 208 into the incoupler 212 so that display light is coupled into incoupler 212 at the appropriate angle to encourage the propagation of the display light in lightguide 205 by TIR. Also, in some embodiments, an exit pupil expander (EPE) (e.g., EPE 324 of FIG. 3, described below) is arranged in an intermediate stage between incoupler 212 and outcoupler 216 to receive display light that is coupled into lightguide 205 by the incoupler 212, expand the display light, and redirect the display light towards the outcoupler 216, where the outcoupler 216 then couples the display light out of lightguide 205 (e.g., toward the eye 222 of the user).

FIG. 3 illustrates a lightguide exit pupil expansion system 300, according to embodiments. In embodiments, lightguide exit pupil expansion system 300 is implemented in, for example, display system 100 and is configured to provide an image to an eye 222 of a user of an HWD. To this end, lightguide exit pupil expansion system 300 includes optical engine 202, optical scanner 204, and lightguide 205. According to embodiments, optical engine 202 is configured to project display light 218 (e.g., light having one or more wavelengths associated with white light, green light, red light, blue light, infrared light, ultraviolet light, or any combination thereof) towards optical scanner 204. In response to receiving display light 218, optical scanner 204 is configured to scan display light 218 along at least a first scanning axis 326, for example, by using one or more scan mirror 206, 208 each configured to oscillate about a respective axis 219, 221. Optical scanner 204 is then configured to provide display light 218 as scanned along at least a first scanning axis 326 to incoupler 212 of lightguide 205.

After receiving display light 218, incoupler 212 is configured to guide display light 218 from incoupler 212 to EPE 324 via at least a portion of lightguide 205. For example, incoupler 212 guides display light 218 from incoupler 212 such that display light 218 propagates through at least a portion of lightguide 205 via TIR, PIR, or both and is received at EPE 324. To this end, incoupler 212 includes one or more incoupler structures 328 each configured to reflect display light 218 in one or more directions into a portion of lightguide 205. Such incoupler structures 328, for example, reflective facets, electrochromic facets, beam splitters (e.g., polarized beam splitters), mirrors (e.g., dielectric mirrors, dichromic mirrors), reflective coatings (e.g., metallic coatings, holograms), or any combination thereof disposed on a surface of or within lightguide 205 and configured to reflect light based on one or more parameters of the incoupler structures 328. Such parameters, for example, include the shape, the angle, the duty cycle, the width, the depth, the fill factor, or any combination of the incoupler structures 328.

In response to receiving display light 218 from the incoupler 212 (e.g., via at least a portion of lightguide 205), EPE 324 is configured to expand the eyebox of the display represented by display light 218. For example, EPE 324 is configured to reflect display light 218 such that the exit pupil of display light 218 is enlarged (e.g., expanded). To expand the exit pupil of display light 218, EPE 324 includes, for example, one or more fanout structures 330 that are configured to reflect received light (e.g., display light 218) so as to increase the size of the exit pupil of the light. Such fanout structures 330, for example, include reflective facets, electrochromic facets, beam splitters (e.g., polarized beam splitters), mirrors (e.g., dielectric mirrors, dichromic mirrors), reflective coatings (e.g., metallic coatings, holograms), or any combination thereof disposed on a surface of or within lightguide 205 configured to reflect light based on one or more parameters (e.g., shape, angle, duty cycle, width, depth, fill factor) of fanout structures 330. According to embodiments, EPE 324 provides display light 218 with the expanded exit pupil to at least a second portion of lightguide 205 configured to propagate display light 218 (e.g., via TIR, PIR) toward outcoupler 216. For example, fanout structures 330 are configured to reflect received display light 218 such that the exit pupil of display light 218 is expanded and display light 218 is provided to outcoupler 216 via at least a second portion of lightguide 205. Outcoupler 216 is then configured to direct received display light 218 out of lightguide 205 and towards the eye 222 of a user. To this end, outcoupler 216 includes one or more outcoupler structures 332 configured to diffract or reflect received display light 218 out of lightguide 205. Outcoupler structures 332 include, for example, reflective facets, electrochromic facets, beam splitters (e.g., polarized beam splitters), mirrors (e.g., dielectric mirrors, dichromic mirrors), reflective coatings (e.g., metallic coatings, holograms), or any combination thereof disposed on a surface of or within lightguide 205 and configured to reflect light based on one or more parameters (e.g., shape, angle, duty cycle, width, depth, fill factor) of outcoupler structures 332 such that the light is directed out of lightguide 205 and toward the eye 222 of a user.

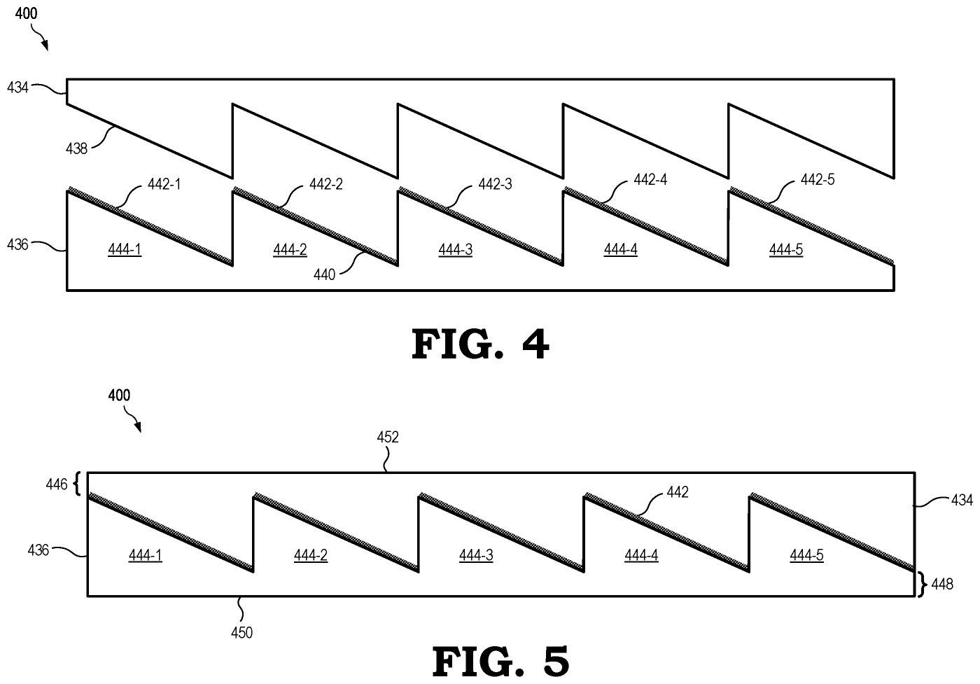

Referring now to FIGS. 4 and 5, FIGS. 4 and 5 together present example lightguide 400 formed from two or more substrates. In some embodiments, example lightguide 400 is implemented in projection system 200 as lightguide 205. According to embodiments, example lightguide 400 includes a first substrate 436 formed from a transmissive material with a refractive index that allows for light to propagate via TIR, PIR, or both. As an example, first substrate 436 is formed from plastic (e.g., acrylic plastic), glass (e.g., doped glass), lithium bionate, a polymer, sapphire, or any combination thereof. First substrate 436, for example, includes a first pattern of structures 440 disposed on a surface of first substrate 436 or within first substrate 436 that represent one or more reflective structures. As an example, first substrate 436 includes a first pattern of structures 440 disposed on a surface of first substrate 436 or within first substrate 436 that form at least a portion of one or more reflective structures of incoupler structures 328, fanout structures 330, outcoupler structures 332, or any combination thereof. In some embodiments, each structure in the first pattern of structures 440 forms one or more reflective structures. These reflective structures 444, for example, each include one or more reflective facets, electrochromic facets, beam splitters (e.g., polarized beam splitters), mirrors (e.g., dielectric mirrors, dichromic mirrors), or any combination thereof. To this end, in some embodiments, first substrate 436 also includes one or more coatings (442-1, 442-2, 442-3, 442-4, 442-5) deposited on one or more structures of the first pattern of structures 440 so as to form one or more reflective structures 444. Such coatings 442, for example, include dielectric mirror coatings, metallic coatings, holographic coatings, dichroic mirror coatings, polarization-selective mirror coatings, and the like. Though the example embodiment presented in FIGS. 4 and 5 presents first substrate 436 as including five reflective structures (444-1, 444-2, 444-3, 444-4, 444-5), in other embodiments, first substrate 436 can include any number of reflective structures.

According to embodiments, example lightguide 400 further includes second substrate 434 formed from a transmissive material with a refractive index that allows for light to propagate via TIR, PIR, or both. As an example, second substrate 434 is formed from plastic (e.g., acrylic plastic), glass (e.g., doped glass), lithium bionate, a polymer, sapphire, or any combination thereof. In embodiments, second substrate 434 includes a second pattern of structures 438 disposed on a surface of first substrate 436 or within second substrate 434. This second pattern of structures 438, for example, includes a pattern of structures that represents a negative (e.g., inverse) of the first pattern of structures 440. As an example, the second pattern of structures 438 includes one or more structures configured to fit flush with one or more structures of the first pattern of structures 440, one or more reflective structures 444, or both. Due to second substrate 434 having the second pattern of structures 438, first substrate 436 is configured to be coupled with second substrate 434 such that second substrate 434 sits flush with first substrate 436 and such that first substrate 436 and second substrate 434 form example lightguide 400. For example, referring to the example embodiment presented in FIG. 5, second substrate 434 sits flush with first substrate 436 so as to form example lightguide 400 having a first surface 450 and a second surface 452.

However, coupling second substrate 434 to first substrate 436 to form example lightguide 400 requires second substrate 434 to have a pattern of structures (e.g., the second pattern of structures 438) representing an inverse of the pattern of structures (e.g., the first pattern of structures 440) of first substrate 436. Forming such a pattern of structures on second substrate 434 increases the complexity of forming the example lightguide 400, increases the time and cost needed to produce the example lightguide 400. Additionally, due to factors in the fabrication process, the structures formed on first substrate 436 and second substrate 434 introduce a thickness of substrate between the end of a reflective structure 444 and a surface 450, 452 of example lightguide 400. For example, referring to the example embodiment of FIG. 5, example lightguide 400 includes a first thickness 448 (e.g., a thickness of first substrate 436) between the ends of one or more reflective structures (e.g., reflective structure 444-5) and the first surface 450 of example lightguide 400. Likewise, example lightguide 400 includes a second thickness 446 (e.g., a thickness of second substrate 434) between the ends of one or more reflective structures (e.g., reflective structure 444-1) and the second surface 452 of example lightguide 400. Such thicknesses 446, 448, for example increase the amount of substrate needed to form example lightguide 400, increasing the cost needed to form example lightguide 400. Additionally, such thicknesses 446, 448 increase the thickness and weight of the lightguide 400, increasing the thickness and weight of any HMD including such a lightguide 400 and negatively impacting user experience.

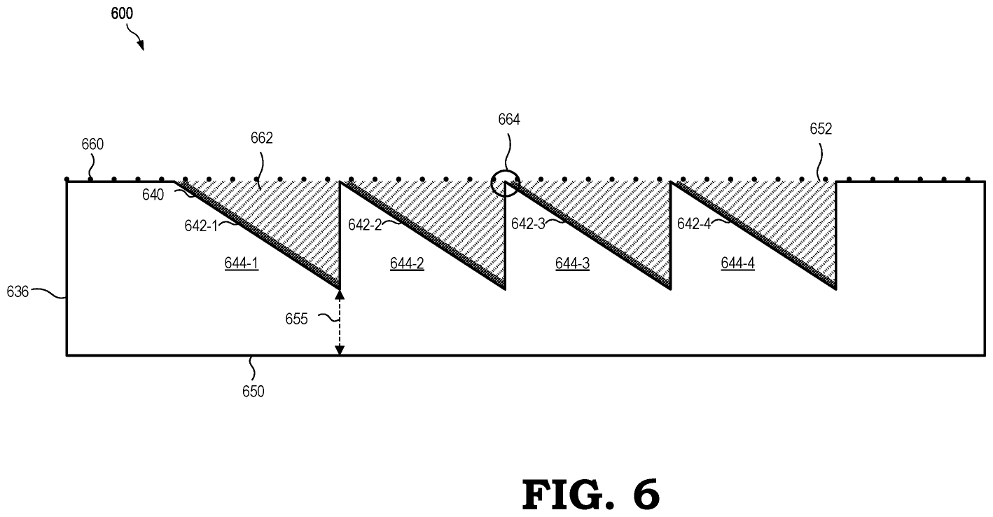

To this end, in some embodiments, a lightguide (e.g., lightguide 205) is formed from a single substrate so as to help reduce the complexity and cost needed to form such a lightguide. For example, referring to FIG. 6, an example lightguide 600 formed from a single substrate is presented. In embodiments, example lightguide 600 is implemented within projection system 200 as lightguide 205. Example lightguide 600 is formed from substrate 636 similar to or the same as first substrate 434. Substrate 636 includes (e.g., is formed from) plastic (e.g., acrylic plastic), glass (e.g., doped glass), lithium bionate, a polymer, sapphire, or any combination thereof. Further, substrate 636 includes a pattern of structures 640 disposed on a surface of substrate 636 or within substrate 636. As an example, first substrate 436 includes a pattern of structures 640 molded, formed from, embossed on, or any combination thereof at least a portion of substrate 636. In embodiments, each structure of the pattern of structures 640 forms at least a portion of one or more reflective structures of incoupler structures 328, fanout structures 330, outcoupler structures 332, or any combination thereof. As an example, in some embodiments, each structure in the pattern of structures 640 forms one or more reflective structures 644-1, 644-2, 644-3, 644-4. These reflective structures 644, for example, each include one or more reflective facets, electrochromic facets, beam splitters (e.g., polarized beam splitters), mirrors (e.g., dielectric mirrors, dichromic mirrors), or any combination thereof. According to some embodiments, to form one or more reflective structures 644, substrate 636 also includes one or more coatings (642-1, 642-2, 642-3, 642-4) deposited on one or more structures of the first pattern of structures 440 so as to form one or more reflective structures 444. Such coatings 642, for example, include dielectric mirror coatings, metallic coatings, holographic coatings (e.g., color-selective holographic coatings), dichroic mirror coatings, polarization-selective mirror coatings, and the like. In some embodiments, one or more reflective structures 644 have the same coating 642 disposed thereon, one or more reflective structures 644 have different coatings 642 disposed thereon, or both. As an example, a first reflective structure 644-1 includes a coating 642-1 that includes dielectric mirror coating and a second reflective structure 644-2 includes a coating 642-2 that includes a holographic coating.

In embodiments, example lightguide 600 further includes an overcoat material 662 deposited on each reflective structure 644 so at form, together with substrate 636, a first surface 652 (e.g., top surface) of example lightguide 600. Such an overcoat material 662 includes an effectively transparent material (e.g., a material allowing a view through the material), such as plastic or the like, injection molded, spin coated, blade coated, slot coated, laminated, or any combination thereof on each reflective structure 644. In some embodiments, overcoat material 662 includes one or more layers of film laminated on the surface of example lightguide 600. Such layers of film, according to some example embodiments, each have a thickness between 25 microns and 100 microns. In this way, substrate 636 together with overcoat material 662 form the example lightguide 600 having one or more reflective structures 644, a first surface 652 (e.g., a top surface) and a second surface 650 (e.g., bottom surface). According to some embodiments, the first surface 652 and the second surface 650 each include planar surfaces. In some embodiments, example lightguide 600 further includes a surface coating 660 deposited over the first surface 652 so as to protect the example lightguide 600, provide one or more properties to the first surface 652 of the example lightguide 600 (e.g., oleophobic properties, hydrophobic properties) or both. That is to say, example lightguide 600 includes a surface coating 660 deposited over the overcoat material 662 deposited on each reflective structure 644 of example lightguide 600. Surface coating 660, for example, a hard coating, oleophobic coating, hydrophobic coating, or any combination thereof deposited on the first surface 652 of example lightguide 600 via, for example, lamination techniques.

By forming the first surface 652 of example lightguide 600 from a single substrate 636 and overcoat material 662, example lightguide 600 reduces the thickness of material (e.g., overcoat material 662) between an end of a reflective structure 644 and the first surface 652 when compared to a lightguide formed from two substrates, such as example lightguide 400. Referring to the example embodiment presented in FIG. 6, the thickness of overcoat material 662 between the end 664 of reflective structure 644-3 and the first surface 652 is effectively zero (e.g., the example lightguide 600 functions as if there is no thickness of material between reflective structure 644-3 and the first surface 652). As an example, in some embodiments, the thickness of overcoat material 662 between the end 664 of reflective structure 644-3 and the first surface 652 is less than 1 micron. However, due to factors in the fabrication process of example lightguide 600, for example, the structures (e.g., reflective structures 644) formed on substrate 636 introduce a thickness 655 of substrate 636 between a second end (e.g., bottom end) of the reflective structures 644 and the second surface 650 of example lightguide 600.

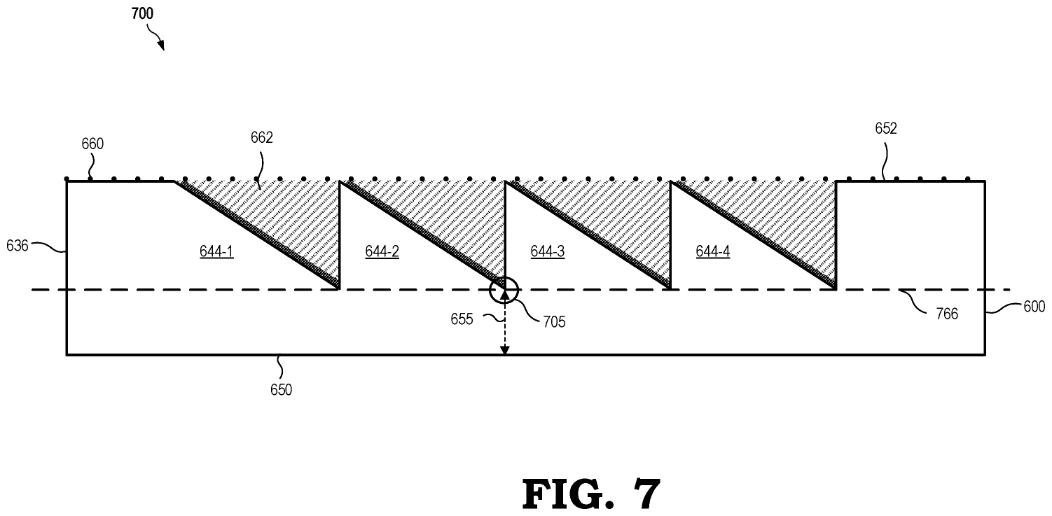

To help reduce thickness 655, in embodiments, example lightguide 600 is cut, polished, or both so as to reduce thickness 655. To this end, referring to FIG. 7, an example material removal operation 700 for removing material from a single substrate lightguide is presented, in accordance with some embodiments. In embodiments, example material removal operation 700 is implemented during a fabrication process of example lightguide 600. For example, in some embodiments, example material removal operation 700 includes cutting, polishing, or both at least a portion of substrate 636 such that the thickness 655 of substrate 636 between one or more ends 705 of one or more reflective structures 644 and the second surface 650 (e.g., bottom surface) of example lightguide 600 is reduced. For example, according to embodiments, example operation 700 includes cutting, polishing, or both at least a portion of substrate 636 such that the thickness 655 of substrate 636 between the end of 705 (e.g., bottom end) of reflective structure 644-2 and the second surface 650 is reduced. To this end, example operation 700 includes removing material (e.g., substrate 636) from example lightguide along a line 766. The line 766, for example, represents a line or plane running parallel to the first surface 652, the second surface 650, or both along which to cut, polish, or both example lightguide 600. As an example, line 766 represents a plane running across example lightguide 600 that will form a new surface of the example lightguide 600 after at least a portion of substrate 636 is removed via cutting, polishing, or both along line 766. In embodiments, after removing material along line 766, example lightguide 600 will have a new surface (e.g., bottom surface) that has a smaller thickness of substrate 636 between one or more ends 705 of one or more reflective structures 644 and the new surface than the thickness 655 of substrate 636 between one or more ends 705 of one or more reflective structures 644 and the second surface 650.

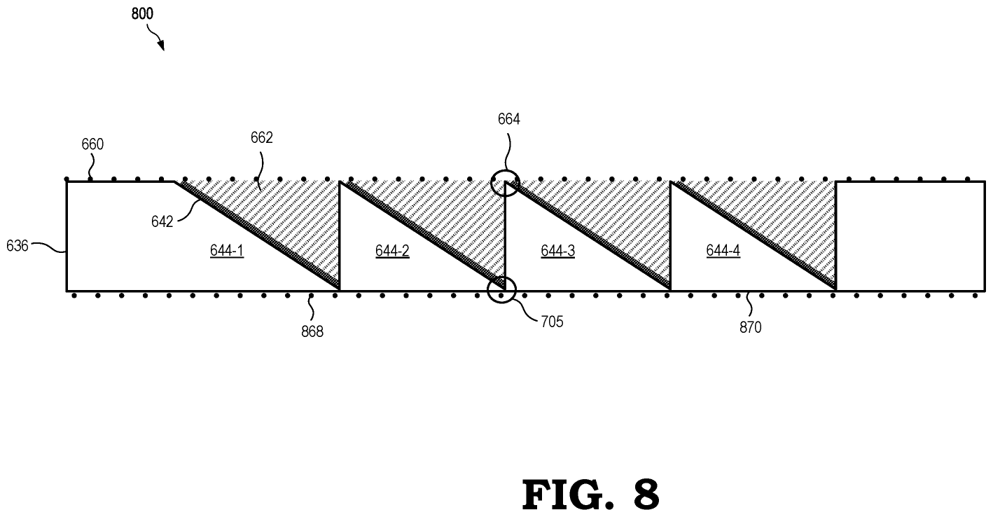

For example, referring now to FIG. 8, example lightguide 800 after a material removal operation is presented, in accordance with some embodiments. In embodiments, example lightguide 800 represents example lightguide 600 after example material removal operation 700 is performed. According to embodiments, example lightguide 800 includes a second surface 870 (e.g., bottom surface) resulting from the performance of example material removal operation 700. Due to the second surface 870, the thickness of substrate 636 between the ends 705 (e.g., bottom ends) of one or more reflective structures 644 and the first surface 652 is effectively zero (e.g., the example lightguide 800 functions as if there is no thickness of material between reflective the ends of the reflective structures 644 and the second surface 870. For example, referring to the example embodiment presented in FIG. 8, the thickness of substrate 636 between the end 705 (e.g., bottom end) of reflective structure 644-3 and the second surface 870 is effectively zero. In some embodiments, the thickness of overcoat material 662 between the ends of one or more reflective structures and the second surface 870 is less than 1 micron. According to embodiments, example lightguide 800 further includes a surface coating 868 deposited over the second surface 870 so as to protect the example lightguide 800, provide one or more properties to the second surface 870 (e.g., oleophobic properties, hydrophobic properties), or both. Surface coating 868, for example, includes a hard coating, oleophobic coating, hydrophobic coating, or any combination thereof deposited on the second surface 870 of example lightguide 800 via, for example, lamination techniques.

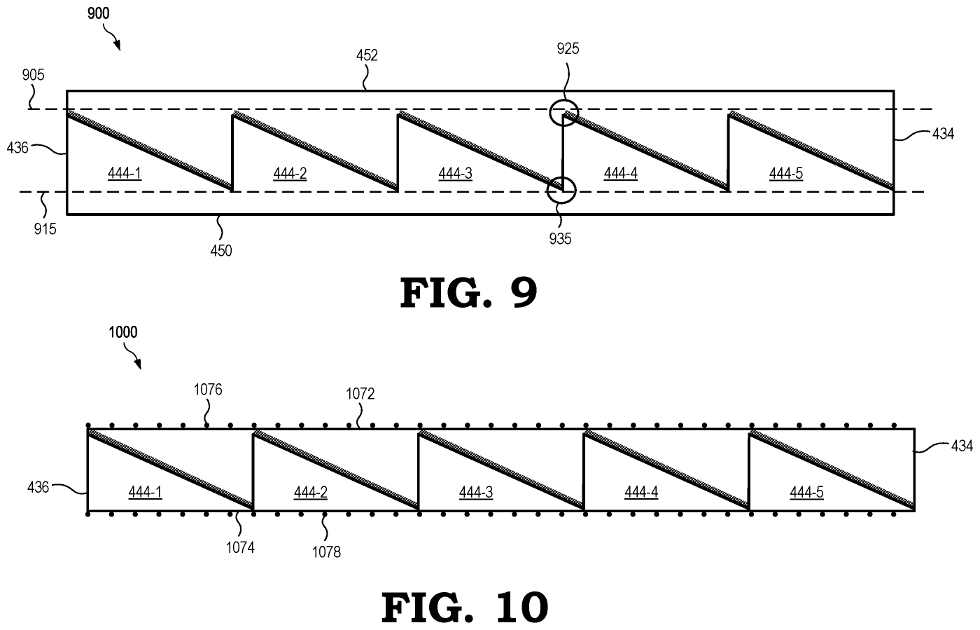

Referring to FIG. 9, an example operation 900 for removing material from a lightguide formed from two substrates is presented, in accordance with some embodiments. In embodiments, example material removal operation 900 is implemented during a fabrication process of example lightguide 400. For example, in some embodiments, example material removal operation 900 includes cutting, polishing, or both at least a portion of substrate 434 such that the second thickness 446 of substrate 434 between one or more ends of one or more reflective structures 444 and the second surface 452 (e.g., top surface) of example lightguide 400 is reduced. For example, according to embodiments, example operation 900 includes cutting (e.g., laser cutting, blade cutting), polishing, or both at least a portion of substrate 436 such that the second thickness 446 of substrate 434 between an end of 925 (e.g., top end) of reflective structure 444-4 and the second surface 452 is reduced. To this end, example operation 900 includes removing material (e.g., a portion of substrate 434) from example lightguide 400 along a line 905. The line 905, for example, represents a line or plane running parallel to the first surface 450, the second surface 452, or both along which to remove material from example lightguide 400. As an example, line 905 represents a plane running across example lightguide 400 that will form a new surface of the example lightguide 400 after material is removed along line 905 via cutting, polishing, or both. According to embodiments, after removing material along line 905, example lightguide 400 will have a new surface (e.g., top surface) that has a smaller thickness of substrate 434 between one or more ends 925 of one or more reflective structures 444 and the new surface than the second thickness 446 of substrate 434 between one or more ends 925 of one or more reflective structures 444 and the second surface 452.

Likewise, in some embodiments, example operation 900 includes removing at least a portion of substrate 436 such that the first thickness 448 of substrate 436 between one or more ends 935 (e.g., bottom ends) of one or more reflective structures 444 and the first surface 450 (e.g., bottom surface) of example lightguide 400 is reduced. To this end, example operation 900 includes removing material (e.g., a portion of substrate 436) from example lightguide 400 along a line 915 that represents a line or plane running parallel to the first surface 450, the second surface 452, or both along which to remove material from example lightguide 400. In embodiments, after removing material along line 915 via cutting, polishing, or both, example lightguide 400 will have a new surface (e.g., bottom surface) that has a smaller thickness of substrate 436 between one or more ends 935 of one or more reflective structures 444 and the new surface than the first thickness 448 of substrate 436 between one or more ends 935 of one or more reflective structures 444 and the first surface 450.

Referring now to FIG. 10, example lightguide 1000 formed from two substrates after a material removal operation is presented, in accordance with some embodiments. In embodiments, example lightguide 1000 represents example lightguide 400 after example material removal operation 900 is performed. In embodiments, example lightguide 1000 includes a second surface 1072 (e.g., top surface) resulting from the performance of example material removal operation 900. Due to the second surface 1072, the thickness of substrate 434 between the ends (e.g., top ends) of one or more reflective structures 444 and the second surface 1072 is effectively zero (e.g., the example lightguide 1000 functions as if there is no thickness of material between reflective the ends of the reflective structures 444 and the second surface 1072). In some embodiments, the thickness of substrate 434 between the ends of one or more reflective structures 444 and the second surface 1072 is less than 1 micron. Similarly, example lightguide 1000 includes a first surface 1074 (e.g., bottom surface) resulting from the performance of example material removal operation 900. Due to the first surface 1074, the thickness of substrate 436 between the ends (e.g., bottom ends) of one or more reflective structures 444 and the first surface 1074 is effectively zero. In some embodiments, the thickness of substrate 436 between the ends of one or more reflective structures 444 and the first surface 1074 is less than 1 micron.

According to embodiments, example lightguide 800 further includes a surface coating 1078 deposited over the first surface 1074, a surface coating 1076 deposited over the second surface 1072, or both so as to protect the example lightguide 1000, provide one or more properties to the first surface 1074 (e.g., oleophobic properties, hydrophobic properties), provide one or more properties to the second surface 1072 (e.g., oleophobic properties, hydrophobic properties), or any combination thereof. Each Surface coating 1076, 1078, for example, includes a hard coating, oleophobic coating, hydrophobic coating, or any combination thereof deposited on the first surface 1074 or second surface 1072, respectively, via, for example, lamination techniques.

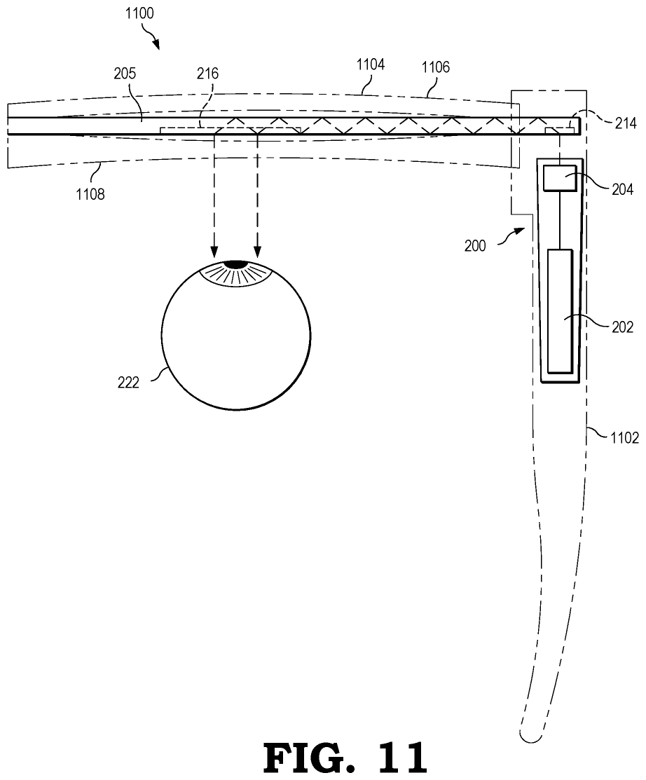

FIG. 11 illustrates a portion of an HMD 1100 that includes a lightguide after one or more cutting processes. For example, according to embodiments, HMD 1100 includes one or more lightguides 205 each formed from a single substrate, similar to or the same as example lightguide 800. As another example, HMD 1100 includes one or more lightguides 205 formed from two substrates that underwent a cutting process, similar to or the same as example lightguide 1000. In some embodiments, the HMD 1100 represents the display system 100 of FIG. 1. The optical engine 202, optical scanner 204, and a portion of the lightguide 205 with incoupler 214 are included in an arm 1102 of the HMD 1100, in the present example.

The HMD 1100 includes an optical combiner lens 1104 which includes a first lens 1106, a second lens 1108, and the lightguide 205, with the lightguide 205 disposed between the first lens 1106 and the second lens 1108. Display light 218 exiting through the outcoupler 216 travels through the second lens 1108 (which corresponds to, for example, the lens element 110 of the display system 100). In use, the light exiting second lens 1108 enters the pupil of an eye 222 of a user wearing the HMD 1100, causing the user to perceive a displayed image carried by the display light 218 output by one or more optical engines 202.

According to embodiments, the optical combiner lens 1104 is substantially transparent, such that light from real-world scenes corresponding to the environment around the HMD 1100 passes through the first lens 1106, the second lens 1108, and the lightguide 205 to the eye 222 of the user. In this way, images, or other graphical content output by the projection system 200 are combined (e.g., overlayed) with real-world images of the user's environment when projected onto the eye 222 of the user to provide an AR experience to the user.

Although not shown in the depicted example, in some embodiments additional optical elements are included in any of the optical paths between the optical engines 202 and the incoupler 214, in between the incoupler 214 and the outcoupler 216, in between the outcoupler 216 and the eye 222 of the user (e.g., in order to shape the display light for viewing by the eye 222 of the user), or any combination thereof. As an example, a prism is used to steer light from the optical scanner 204 into the incoupler 214 so that light is coupled into incoupler 214 at the appropriate angle to encourage propagation of the light in lightguide 205 by TIR. Also, in some embodiments, one or more exit pupil expanders (e.g., the EPE 324) including, for example, fanout structures 330 are arranged in an intermediate stage between incoupler 214 and outcoupler 216 to receive light that is coupled into lightguide 205 by the incoupler 214, expand the light, and redirect the light towards the outcoupler 216 where the outcoupler 216 then couples the display light out of the lightguide 205 (e.g., toward the eye 222 of the user).

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A lightguide, comprising:
a substrate;
a plurality of reflective structures disposed on the substrate; and
an overcoat material disposed over the plurality of reflective structures so as to form at least a portion of a first surface of the lightguide.

2. The lightguide of claim 1, wherein a thickness of the substrate between a first end of a reflective structure of the plurality of reflective structures and the first surface of the lightguide is less than 1 micron.

3. The lightguide of claim 2, wherein a thickness of the substrate between a second end of the reflective structure of the plurality of reflective structures and a second, opposing surface of the lightguide is less than 1 micron.

4. The lightguide of claim 3, further comprising an oleophobic coating disposed on the second, opposing surface of the lightguide.

5. The lightguide of claim 1, further comprising:
a hard coating deposited on the first surface of the lightguide.

6. The lightguide of claim 1, further comprising a first mirror coating disposed on a first reflective structure of the plurality of reflective structures.

7. The lightguide of claim 6, further comprising a second mirror coating disposed on a second reflective structure of the plurality of reflective structures, wherein the first mirror coating is different from the second mirror coating.

8. A head-worn display (HWD), comprising:
a projector configured to emit light representing an image; and
a lightguide configured to direct the light representing the image to an eye of a user, wherein the lightguide comprises:
a substrate;
a plurality of reflective structures disposed on the substrate; and
an overcoat material disposed over the plurality of reflective structures so as to form at least a portion of a first surface of the lightguide.

9. The HWD of claim 8, wherein a thickness of the substrate between a first end of a reflective structure of the plurality of reflective structures and the first surface of the lightguide is less than 1 micron.

10. The HWD of claim 9, wherein a thickness of the substrate between a second end of the reflective structure of the plurality of reflective structures and a second, opposing surface of the lightguide is less than 1 micron.

11. The HWD of claim 10, wherein the lightguide further comprises a hydrophobic coating disposed on the second, opposing surface of the lightguide.

12. The HWD of claim 8, wherein the lightguide further comprises a hard coating deposited on the first surface of the lightguide.

13. The HWD of claim 8, wherein the lightguide further comprises a first mirror coating disposed on a first reflective structure of the plurality of reflective structures.

14. The HWD of claim 13, wherein the lightguide further comprises a second mirror coating disposed on a second reflective structure of the plurality of reflective structures, wherein the first mirror coating is different from the second mirror coating.

15. A method, comprising:
forming, on a substrate, a plurality of reflective structures;
depositing an overcoat material over the plurality of reflective structures so as to form at least a portion of a first surface of a lightguide; and
cutting at least a portion of the substrate so at to form a second, opposing surface of the lightguide.

16. The method of claim 15, wherein cutting the at least a portion of the substrate include cutting at least a portion of the substrate so at to reduce a thickness of the substrate between an end of a reflective structure of the plurality of reflective structures and the second, opposing surface of the lightguide.

17. The method of claim 16, wherein the thickness of the substrate between a first end of the reflective structure of the plurality of reflective structures and the second, opposing surface of the lightguide after the cutting is less than 1 micron.

18. The method of claim 17, wherein a thickness of the substrate between a second end of the reflective structure of the plurality of reflective structures and the first surface of the lightguide is less than 1 micron.

19. The method of claim 15, further comprising:
depositing an oleophobic coating on the second, opposing surface of the lightguide.

20. The method of claim 15, further comprising:
depositing a first mirror coating on a first reflective structure of the plurality of reflective structures and a second mirror coating on a second reflective structure of the plurality of reflective structures, wherein the first mirror coating is different from the second mirror coating.
